(19) United States
(12) Patent Application Publication
(10) Pub. No.: US 2023/0322573 A1
(43) Pub. Date: Oct. 12, 2023

(54) CATALYTICALLY ENHANCED PRODUCTION OF ALUMINUM CHLOROHYDRATES

(71) Applicant: BOARD OF REGENTS, THE UNIVERSITY OF TEXAS SYSTEM, Austin, TX (US)

(72) Inventors: Seyed Amir Jafari GHORESHI, Arlington, TX (US); Mohammad Fakrul ISLAM, Arlington, TX (US); Wilaiwan CHANMANEE, Arlington, TX (US); Brian H. DENNIS, Arlington, TX (US); Frederick M. MACDONNELL, Arlington, TX (US)

(21) Appl. No.: 18/021,237

(22) PCT Filed: Jul. 30, 2021
(86) PCT No.: PCT/US2021/043978

§ 371 Date: Feb. 14, 2023

Related U.S. Application Data
(60) Provisional application No. 63/065,979, filed on Aug. 14, 2020.

(51) Int. Cl. B01J 31/16; C01F 7/57

(52) U.S. Cl. CPC C01F 7/57; B01J 31/165; C01P 2006/80

(57) ABSTRACT

In one aspect, methods of producing polyaluminum chlorides are described herein which, in some embodiments, provide increased reaction rates and/or reductions in stoichiometric excesses of aluminum feedstock. In some embodiments, a method of producing polyaluminum chloride comprises providing a feedstock comprising aluminum, contacting the feedstock with a solution comprising hydrochloric acid and one or more transition metal compounds, and catalyzing formation of the polyaluminum chloride with the one or more transition metals. As described further herein, the one or more transition metal compounds can comprise a transition metal coordination complex, transition metal salt, or mixtures thereof.

### CROSS-REFERENCE TO RELATED APPLICATIONS

The present application is an international application claiming priority under Article 8 of the Patent Cooperation Treaty to U.S. Provisional Application No. 63/065,979 filed on Aug. 14, 2020, the contents and substance of which are incorporated herein, in their entirety, by reference.

### FIELD

The present invention relates to the production of aluminum chlorohydrates and, in particular, to the use of transition metal catalyst to enhance reaction rates of aluminum chlorohydrate production.

### BACKGROUND

Aluminum chlorohydrate is a highly water-soluble aluminum complex with the general formula AlₙCl₍₃ₙ₋ₘ₎(OH)ₘ and which meets certain specifications in specific gravity, pH, basicity, turbidity, and Al content. Aluminum chlorohydrate, which is a polymerized solution of polyaluminum hydroxychloride, contains 12% aluminum by mass and is the most concentrated homogeneous aluminum solution commercially available. Removal of some of the water from ACH results in a solid in which the aluminum content varies between 46-50%. The basicity of ACH, the degree of the aluminum polymerization and acid neutralization, is a measure of its neutralizing capacity and is reported as the ratio of OH— per aluminum charge. If 5 of the 6 positive charges on the aluminum are offset by hydroxides, the basicity would be 83%, which is the specification value for ACH. A basicity of 83% is also the highest basicity available in a stable solution form for any polyaluminum solution. Because of the high basicity, ACH is more efficient in coagulating the negatively charged contaminants in a water treatment process than other aluminum salts including alum, aluminum chloride, and related polyaluminum compounds, and leaves fewer negatively charged counterions in the resulting clarified solution.

ACH has a wide variety of applications including drinking water treatment, sewage and industrial waste water treatment, and paper and cosmetics manufacturing. However, several disadvantages currently exist with current ACH and other polyaluminum chloride production. Aluminum ingots are the preferred aluminum source for ACH production. Due to low surface area, reaction of the ingots with hydrochloric acid solution is slow, usually taking 4-7 days for completion. The reaction of aluminum metal with aqueous hydrochloric acid proceeds according to the reaction below (1), which is commonly referred to as the “oxidation reaction” as the Al metal is oxidized to Al(III):

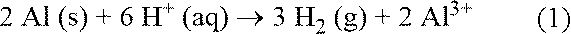

Additionally, ACH production requires high stoichiometric excesses of aluminum feedstock, often resulting in wasteful unreacted aluminum.

### SUMMARY

In one aspect, methods of producing polyaluminum chlorides are described herein which, in some embodiments, provide increased reaction rates and/or reductions in stoichiometric excesses of aluminum feedstock. In some embodiments, a method of producing polyaluminum chloride comprises providing a feedstock comprising aluminum, contacting the feedstock with a solution comprising hydrochloric acid and one or more transition metal compounds, and catalyzing formation of the polyaluminum chloride with the one or more transition metals. As described further herein, the one or more transition metal compounds can comprise a transition metal coordination complex(es), transition metal salt(s), or mixtures thereof.

In another aspect, a method of producing polyaluminum chloride comprises providing a feedstock comprising aluminum, contacting the feedstock with a solution comprising hydrochloric acid, and catalyzing formation of the polyaluminum chloride with solid state transition metal or solid state transition metal alloy or combinations thereof. Solid state transition metal or solid state transition metal alloy, in some embodiments, can be in particulate form, wire-mesh, wool, or combinations thereof.

Polyaluminum chlorides produced according to methods described herein include, but are not limited, to high basicity polyaluminum chloride and ultra-high basicity polyaluminum chloride. In some embodiments, ultra-high basicity polyaluminum chloride produced according to methods described herein is ACH.

These and other embodiments are further described in the following detailed description.

### BRIEF DESCRIPTION OF THE DRAWINGS

FIG. 1 illustrates total reaction time of ACH synthesis for aluminum feedstocks of varying impurity levels.

FIG. 2 illustrates total reaction time of ACH synthesis upon addition of various metal salts, according to some embodiments.

FIG. 3 illustrates chemical structures of various chelating ligands, according to some embodiments.

FIG. 4A illustrates total reaction time of ACH synthesis for various Ni-catalysts, according to some embodiments.

FIG. 4B illustrates total reaction time of ACH synthesis at various Ni-catalyst loadings, according to some embodiments.

FIG. 5A illustrates total reaction time of ACH synthesis for various Fe-catalysts, according to some embodiments.

FIG. 5B illustrates total reaction time of ACH synthesis for at various Fe-catalyst loadings, according to some embodiments.

FIG. 6 illustrated reaction batch times for P0610 ingot with different Fe/IDA catalyst combinations, according to some embodiments.

### DETAILED DESCRIPTION

Embodiments described herein can be understood more readily by reference to the following detailed description and examples. Elements, apparatus and methods described herein, however, are not limited to the specific embodiments presented in the detailed description and examples. It should be recognized that these embodiments are merely illustrative of the principles of the present invention. Numerous modifications and adaptations will be readily apparent to those of skill in the art without departing from the spirit and scope of the invention.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, or 4.7 to 10.0, or 3.6 to 7.9. Similarly, a stated range of “1 to 10” should be considered to include any and all subranges beginning with a minimum value of 1 or more and ending with a maximum value of 10 or less, e.g., 1 to 5, or 4 to 10, or 3 to 7, or 5 to 8.

All ranges disclosed herein are also to be considered to include the end points of the range, unless expressly stated otherwise. For example, a range of “between 5 and 10” or “from 5 to 10” or “5-10” should generally be considered to include the end points 5 and 10.

In one aspect, a method of producing polyaluminum chloride comprises providing a feedstock comprising aluminum, contacting the feedstock with a solution comprising hydrochloric acid and one or more transition metal compounds, and catalyzing formation of the polyaluminum chloride with the one or more transition metals of the compound(s). As described further herein, the one or more transition metal compounds can comprise a transition metal coordination complex, transition metal salt, or mixtures thereof.

Turning now to specific components, the feedstock comprising aluminum can include any feedstock not inconsistent with the technical objectives detailed herein. In some embodiments, the feedstock comprises large form aluminum metal, often in the form of aluminum ingots. Alternatively, the aluminum feedstock may comprise aluminum pellets and/or aluminum powder. The aluminum feedstock can have any desired impurity levels. Impurities in the aluminum feedstock can comprise one or more of silicon, iron, zinc, gallium, vanadium and/or other trace elements. The grade of aluminum feedstock employed in methods described herein can be determined according to several considerations, including specific identity of the polyalumnium chloride to be produced and the end use of the polyaluminum chloride. Notably, methods described herein can increase reaction rates of polyaluminum chloride formation irrespective of the specific aluminum feedstock identity. However, increases in reaction rates may vary according to the specific identity of the aluminum feedstock, with high purity aluminum grades registering the greatest reaction rate increases with transition metal catalysts described herein. In some embodiments, the feedstock is selected from aluminum grades P0303, P0404, P0610, P1015, P1020, and super high purity aluminum (4N and 5N).

The aluminum feedstock is often present in the reaction mixture in stoichiometric excess. The addition of a stoichiometric excess of aluminum (up to 500%) is one effective way in which to speed up the batch process time but leftover, unreacted aluminum, commonly referred to as bones, can have associated issues. Methods described herein can reduce stoichiometric excesses of aluminum while increasing reaction rates and lowering aluminum polychloride production times relative to conventional HCl treatment methods.

The aluminum feedstock is contacted with a solution comprising hydrochloric acid and one or more transition metal compounds, wherein the one or more transition metals catalyze formation of the polyaluminum chloride. Any transition metal compound operable to catalyze polyaluminum chloride formation can be employed. In some embodiments, the transition metal compound is a transition metal coordination complex. A transition metal coordination complex, in some embodiments, comprises one or more chelating ligands. Suitable chelating ligands can have denticities from 2 to 8 or 3 to 5, in some embodiments. Chelating ligands, for example, can be selected from the group consisting of aminopolycarboxylic acids, amino acids, organic acids, amines, α-alcohol organic acids, oximes, polyphosphates, polyphosphonates, and Schiff-base derived ligands. In some embodiments, chelating ligands comprise one or more of ethylenediaminetetraacetic acid (EDTA), ethylenediamine-N,N′-diacetic acid (EDDA1), ethylenediamine-N,N-diacetic acid (EDDA2), nitrilotriacetic acid (NTA), iminodiacetic acid (IDA), methylglycinediacetic acid (MGDA), iminodiscuccinic acid (IDS) and any of the 20 naturally occurring amino acids in the L or D enantiochemistries. Additional chelating ligands can include dimethylglyoxime (DMG), citric acid, ethylenediamine (EN), oxalic acid (OX), salen and salophen.

Alternatively, transition metal compounds of the HCl solution can comprise transition metal salts. Transition metal salts can include acetates, sulfates, phosphates, and halides, such as chlorides. Transition metals of salts and coordination complexes can be selected from Groups 8-12 of the Periodic Table, in some embodiments. The transition metal compound, for example, can comprise Fe, Co, Ni, Cu, Pd, Pt, Ir, Ru, Rh, or Os. A single transition metal compound species may be employed in the HCl solution or a mixture of differing transition metal compounds may be employed. The transition metal compound can be present in the solution in any amount not inconsistent with the technical objectives described herein. In some embodiments, the transition metal compound is present in an amount less than 500 ppm, based on weight of active transition metal. In some embodiments, the transition metal compound is present in an amount of 5 ppm to 500 ppm.

In some embodiments of methods described herein, the formation of the polyaluminum chloride occurs at a reaction rate at least 200 percent faster relative to an absence of the one or more transition metal compounds from the solution. In some embodiments, the reaction is 300-600 times faster. Additionally, in some embodiments, the reaction rate of polyaluminum chloride formation is proportional to aluminum purity in the feedstock. Moreover, stoichiometric excess of the aluminum is reduced relative to polyaluminum chloride production via hydrochloric acid solution free of the one or more transition metal compounds.

In another aspect, a method of producing polyaluminum chloride comprises providing a feedstock comprising aluminum, contacting the feedstock with a solution comprising hydrochloric acid, and catalyzing formation of the polyaluminum chloride with solid state transition metal or solid state transition metal alloy or combinations thereof. Solid state transition metal or solid state transition metal alloy, in some embodiments, can be in particulate form, wire-mesh, wool, or combinations thereof. In some embodiments, the solid state transition metal or solid state transition metal alloy is coated on a substrate. In other embodiments, the solid state transition metal or solid state transition metal alloy is formed by reduction of transition metal ions in the solution. In such embodiments, the particulate transition metal or transition metal alloy can be suspended in the solution, thereby forming a colloid. Alternatively, the particulate transition metal or transition metal alloy may deposit on the aluminum feedstock. The transition metal or transition metal alloy, in some embodiments, can be selected from Groups 5-12 of the Periodic Table.

These and other embodiments are further illustrated in the following non-limiting examples and Appendix attached hereto.

### EXAMPLE 1 - Effect of Internal or External on ACH Reaction Rate

Differential reactivity exhibited by aluminum feedstock in the oxidative production of ACH was investigated with four (4) types of aluminum pellets according to Table I.

TABLE I

Aluminum Pellet Types

| AI Pellet Type | Fe Content (ppm) |
|---|---|
| 1 | 1 |
| 2 | 275 |
| 3 | 850 |
| 4 | 1000 |

For each pellet type, a 2L three-necked round-bottom flask was fitted with a reflux condenser, a thermometer, and charged with 220 g of ¼″ aluminum pellet (8.2 mol, 3 eq), 475 mL water, and then 450 mL 20% HCl (2.7 mol, 1 eq) was added over a 1 h period, during which the reaction starts as seen by the temperature rising to boiling or near boiling and vigorous gas evolution. Under these parameters, the aluminum is initially present at 50% stoichiometric excess relative to the acid or 150% loading. Once the acid addition was complete, the temperature is monitored and the external heat applied when the temperature starts to fall. The reaction temperature is kept between 95 and 100° C. using an external oil bath. The specific gravity was monitored with time and the reaction considered complete when the SG at 25° C. was 1.33 or greater. While this is not always an accurate endpoint, it was accurate for these tests as verified by subsequent Al and Cl mass analysis.

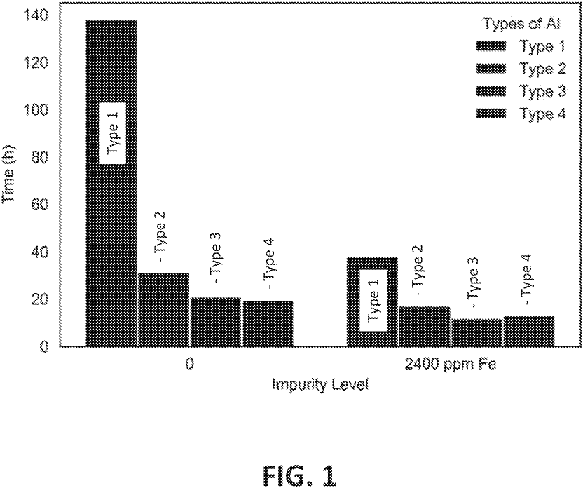

As illustrated in FIG. 1, the total time it takes to complete the ACH synthesis reaction drops dramatically upon going from pellet with 1 ppm Fe to pellet with 275 ppm Fe and even better times are observed with 850 ppm Fe pellet and 1000 ppm Fe pellet. However, it is also observed that increasing the Fe content in the aluminum feedstock has diminishing effectiveness in accelerating the reaction, as reaction times only increase modestly upon going from pellet with 275 ppm Fe to 850 ppm Fe and 1000 ppm Fe. The bar graph on the right-hand side of FIG. 1 shows the total reaction time needed when the same reactions are repeated but enough FeSO₄·7H₂O is added to make the solution 2400 ppm Fe due to the salt addition. The added Fe salt causes the acceleration of each reaction compared to the no external catalyst added runs. Most obvious is the dramatic increase in reaction rate for the ultra-pure Al pellet (Type 1: 1 ppm Fe). Externally added Fe accelerates the reaction with each type (purity) of Al pellet, but the magnitude to the acceleration is attenuated as the internal Fe levels get higher (>1000 ppm). There is also a diminishing catalytic effect upon added more external Fe. If is clearly observed that increasing the Fe concentration (by addition of FeSO₄·7H₂O) from 1600 to 2400 ppm does not improve reaction times using P0610 Al pellet, and the rate with 800 ppm Fe added externally is only slightly slower than at 1600 ppm (16 h vs 13 h). This data is contained in Table 2. It is clearly observed that soluble Fe eventually undergoes reduction to Fe metal upon contact with the Al pile. The appearance of black clumps of Fe powder in the ACH solution is easily shown to be metallic Fe by its attraction to a permanent magnet. It is suspected that the greater the Fe solution concentration the easier it is for these clusters to form and to acts as seeds to reduce/co-crystallize out the other Fe in solution. The most important thing obtained from these experiments is that externally added iron salts do acts as effective catalysts and function well at low concentrations (i.e. <1600 ppm).

### EXAMPLE 2 - Effect of MetalSalts on ACH Reaction Rate

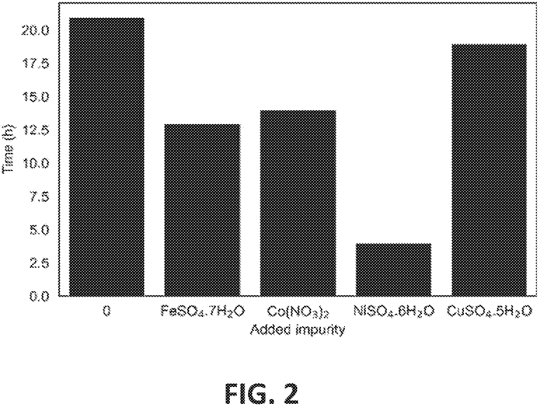

Table 2 summarizes the experiments run with different metal salts and different purities of Al pellet and the total time (Run Time) it took to reach a SG of 1.33. Runs 8, 9, and 10 in Table 2 show the acceleration of the reaction time upon addition of 2400 ppm (metal) of Co(II), Ni(II) and Cu(II) salts. The run times for these runs and for the uncatalyzed run and the 2400 ppm Fe (added) are shown graphically in FIG. 2. In each case, P0610 Al pellets was used and it was clearly observed that the Ni(II) salt is by far the most effective, followed by Fe, then Co, and Cu. The run with added Cu catalyst is only marginally better than the uncatalyzed reaction (no external catalyst added). Addition of NiSO₄.6H₂O (2400 ppm Ni) has the most dramatic effect with a rate enhancement 5.25 fold greater than the uncatalyzed reaction using P0610 catalyst (21 h to 4 h reaction time). Experiments in which the Ni level was lowered to 1600 ppm and then 800 ppm (Table 5, Runs 11 and 12) show the same catalytic efficiency, indicating that less Ni that Fe is needed in such cases.

TABLE 2

ACH Production with Different Metal Salt Additions

| Run | Aluminum Grade | Fe (ppm) in Al | Added Catalyst | Added Metal concentration (ppm) | Run Time (h) |
|---|---|---|---|---|---|
| 1 | 5N | <10 | none | None | 138 |
| 2 | P0610 | 850 | none | None | 21 |
| 3 | 5N | 1 | FeSO₄·7H₂O | 2400 ppm | 38 |
| 4 | P0610 | 850 | FeSO₄·7H₂O | 2400 ppm | 13 |
| 5 | P0303 | 275 | FeSO₄·7H₂O | 2400 ppm | 21 |
| 6 | P0610 | 850 | FeSO₄·7H₂O | 1600 ppm | 13 |
| 7 | P0610 | 850 | FeSO₄·7H₂O | 800 ppm | 16 |
| 8 | P0610 | 850 | Co(NO₃)₂·6H₂O | 2400 ppm | 14 |
| 9 | P0610 | 850 | NiSO₄·6H₂O | 2400 ppm | 4 |
| 10 | P0610 | 850 | CuSO₄·6H₂O | 2400 ppm | 19 |
| 11 | P0610 | 850 | NiSO₄·6H₂O | 1600 ppm | 4 |
| 12 | P0610 | 850 | NiSO₄·6H₂O | 800 ppm | 4 |

The observed catalytic activity of the base transition metals is Ni >> Fe > Co > Cu > none. This trend correlates well with the known overpotential for hydrogen evolution for these metals. Ni metal is the best hydrogen evolving catalyst of the group and has the lowest overpotential for hydrogen evolution as determined electrochemically. As the aluminum is very much capable of reducing any of the metal ions to metal under the reaction conditions, it is unclear if the observed catalysis is due to soluble M(II) species or the formation of metallic colloids, particles, or islands on the Al surface. However, it is shown in subsequent examples herein that soluble chelated complexes of Fe(II) and Ni(II) are better catalysts than the uncomplexed metal ion salts. Therefore, it appears the most effective catalysts are those that are stable is solution. This is not to say the metallic species formed upon reduction of these ions do not participate in the catalysts, only that these catalysts do not appear to be as potent as the soluble ones.

### EXAMPLE 3 - Effect of Solid State Metal on ACH Reaction Rate

ACH synthesis reaction in which the aluminum pellet or ingot was contacted with a Cu or Ni metal screen, wool, or foam (including combinations thereof) was examined and found that, in all cases, the ACH synthesis reaction was enhanced upon contact the solid metal heterogeneous catalyst (see Table 3). These reactions were run as previously described at the laboratory scale). Again the biggest catalytic enhancements were observed for reactions using 5 N aluminum which became less pronounced with less pure Al feedstocks. For example, the catalytic enhancement using copper wool in contact with 5N Al pellet was 5.5 fold (Table 3 Runs 1 and 2), whereas the same reaction run with P0610 pellet only gave a 1.4 fold enhancement (Table 3, Runs 3 and 4). Notably, the final ACH product was not observed to have any dissolved copper in it, indicating that the copper wool did not contaminate the product in any fashion. Analysis here was done by ICP-MS. This needs further study as 4 ppm Cu in the ACH was observed. Nickel metal foam was also very effective as was Ni powder, both showing a 3-fold enhancement in the rate with P0303 pellet, however in both cases some dissolved Ni was observed in the product, with the powder contributing to almost a 100 ppm Ni contamination. As with all heterogeneous catalysts the loading (mass catalyst/mass aluminum) is an important variable that needs further study but it certain that the cost, maintenance, and probability of product contamination increase as more heterogeneous catalyst is used.

TABLE 6

Heterogeneous Catalytic Testing Results

| Run | Experiment | Catalyst | Run time (h) | Final SG | Final M concentration in ACH | |
|---|---|---|---|---|---|---|
| | | | | | Cu (ppm | Ni (ppm |
| 1 | 150% 5N pellet | none | 138 | 1.33 | 0 | 0 |
| 2 | 150% 5N pellet | Cu wool 12.8 g | 25 | 1.33 | 0 | 0 |
| 3 | 150% P0610 pellet | none | 21 | 1.33 | 0 | 0 |
| 4 | 150% P0610 pellet | Cu wool 13 g | 15 | 1.33 | 0 | 0 |
| 5 | 110% P0303 pellet | none | 68 | 1.33 | 0 | 0 |
| 6 | 110% P0303 pellet | Ni foam 7.5 g | 22 | 1.33 | 0 | 2 |
| 7 | 110% P0303 pellet | Ni powder 0.1 g (2-3 µm) | 23 | 1.33 | 0 | 96 |

### EXAMPLE 4 - Effect of Soluble Metal Catalysts on ACH Reaction Rate

Addition of chelating ligands provides a way to stabilize the M(II) ion in solution with respect to reduction to the metal. It can also modify the reactivity of the metal ion to redox reactions and related reactions such as the hydrogen-evolving reaction. The observation that Ni(II) salts were the best catalysts for the ACH synthesis reaction out of the group (including Fe, Co, and Cu) could be rationalized as being because Ni metal has the lowest overpotential got the HER reaction and similarly Ni(II) complexes are typically the best HER catalysts of the group.

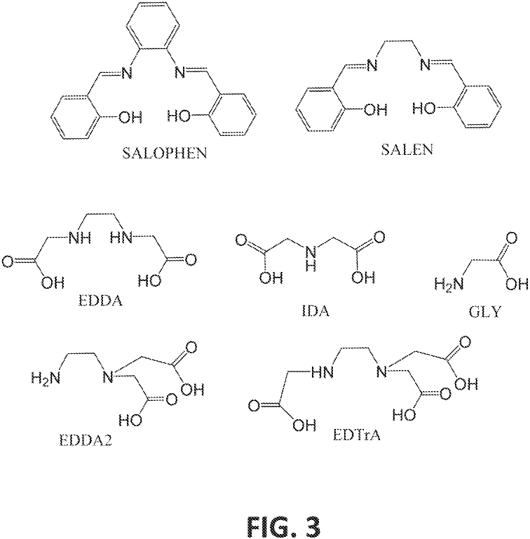

Metal complexing agents are also known as chelating agents and are chemicals that are able to form a complex with certain metal ions. The ASTM-A-380 definition of a chelating agent is: chemicals that form soluble, complex molecules with certain metal ions, inactivating the ions so that they cannot normally react with other elements or ions to produce precipitates or scale.” Chelating ligands are typically organic molecules that have two or more of the following functional groups carboxylic acids, alcohols, amines, imines, amides, oximes, phosphonates, sulfhydryl, and thioethers properly juxtaposed such that the donor atoms (the ones that directly bind the metal ion) when bound form 5 or 6 membered ring structures. Chelating ligands can donate from 2 up to 6 donor atoms for these base transition metals, with the more donor atoms bound the greater the stability of the transition metal chelating ligand complex. Some common examples of chelating ligands for metal ions in aqueous solution and their denticity (donor atom number[d]) are: ethylenediaminetetraacetic acid (EDTA)[6], ethylenediaminediacetic acid (EDDA) [4], tetrasodium (1-hydroxyethylidene)bisphosphonate (ECHA) bi- or tridentate [2 or 3], nitrilotriacetic acid (NTA) [4], iminodiacetic acid (IDA) [3], citric acid [3], glycine (GYL) [2], Also examined were SALEN [4] and SALOPHEN [4] which are Schiff base ligands formed from the condensation reaction of two equivalents of salicylaldehyde with 1,2-diaminoethane (EN) and or 1,2-diaminobenzene (OPD), respectively, and their chemical structures along with a few others shown in FIG. 3.

Ligands which have some selectivity for M(II) ions over M(III) ions are preferred as the ACH solution is highly concentrated in Al(III) ions and is 6.1 M in Al(III) ion in the final ACH product. The presence of donor atoms that are ‘softer’ than oxygen using Hard-Soft Acid-Base theory as the definition of relative hardness is one way to favor coordination of the ‘softer’ M(II) ion over the ‘harder’ Al(III) ion. For our purposes this is done by using N, C, S, or P donor atoms in the ligand.

Table 4 collects the experimental conditions used for ACH synthesis reactions at the ~200 g scale of aluminum ingot (a single rectangular chuck of Al) or aluminum pellet, which was classified as LFAM and SFAM respectively. The majority of the reactions were run with hydrochloric acid but a few used PAX 18 as the acid source, as sometime ACH is prepared from Al and PAX. This is indicated specifically. The Aluminum metal column indicates the loading (%) purity, and form (ingot or pellet). Unless indicated otherwise the pellet was ⅜″ pellet. The loading percentage is based on a 2Al: 1Cl stoichiometry for ACH, and thus a 200% Al loading has 4 molar equivalents of Al metal per chloride present. The reaction, when complete will have half of the initial aluminum remaining. While the run time was initially examined by the SG reading, a measurement of the final Al mass remaining was used to compute the stoichiometry. ACH is prepared when the Al stoichiometry in solution is between 1.9 and 2.1 per Cl ion.

The third column indicates the catalyst added and the 4^{th} column the amount of catalyst added in ppm of metal ion added. The metal salt and the chelating ligand were mixed in a 1:1 molar ratio in a small amount of water before addition. For most ligands the chelation is done in seconds, for most runs using the Schiff-base ligands, the complexes were formed by self-assembly simply by mixing appropriate proportions of the components in water for 30 min before adding to the ACH run. It is important to note that the resulting complexes were not characterized, and the discussion will assume that the complex has formed, but the right to consider that the active catalyst is not the exact complex indicated is reserved. Catalysts were added approximately 2 h after the start of the reaction, as it takes about 2 h to add all of the acid to the batch and then to settle down so as not to be too vigorous. The catalyst is added in small portions over 15 min to prevent a large exothermic reaction. When only chelating ligand was added (no metal salts added), the ppm concentration of the ligand is indicated. Columns 5 and 6 show the total run time and final SG.

TABLE 7 -

Soluble Catalyst Testing Results

| Run | Aluminum Metal | Catalyst | [M] ppm | Run Time (h) | SG |
|---|---|---|---|---|---|
| | LFAM | | | | |
| 1 | 200% 0610 ingot (Roto-1) | none | 0 | 102 | 1.36 |
| 2 | 200% 0610 ingot (Roto-2) | none | 0 | 97 | 1.33 |
| 3 | 225% 0610 ingot (Roto-2)/PAX 18 | none | 0 | 140 | 1.35 |
| 4 | 200% 0610 ingot | Ni(OAc)2 | 50 | 90 | 1.34 |
| 5 | 200% 0610 ingot | Ni(OAc)2/2 DMG | 50 | 44 | 1.32 |
| 6 | 200% 0610 ingot | Ni(OAc)2/OPD/2 Salicylaldehyde | 50 | 26 | 1.33 |
| 7 | 200% 0610 ingot | Ni(OAc)2/OPD/2 Salicylaldehyde | 25 | 27 | 1.34 |
| 8 | 200% 0610 ingot | Ni(OAc)2/OPD/2 Salicylaldehyde | 20 | 36 | 1.35 |
| 9 | 200% 0610 ingot | Ni(OAc)2/OPD/2 Salicylaldehyde | 15 | 60 | 1.33 |
| 10 | 200% 0610 ingot | Ni(OAc)2/OPD/2 Salicylaldehyde | 10 | 93 | 1.33 |
| 11 | 200% 0610 ingot | Ni(OAc)2/EN/2 Salicylaldehyde | 25 | 47 | 1.34 |
| 12 | 200% 0610 ingot | Ni(OAc)2/EDDA1 | 25 | 70 | 1.34 |
| 14 | 200% 0610 ingot | Fe(SO4)/EDDA1 | 100 | 47 | 1.34 |
| 15 | 200% 0610 ingot | EDDA | 0 | 57 | 1.34 |
| 16 | 200% 0610 ingot | Fe(SO4)/EDTA | 100 | 70 | 1.34 |
| 17 | 200% 0610 ingot | Fe(SO4)/Citric acid | 100 | 70 | 1.34 |
| 18 | 200% 0610 ingot | Fe(SO4)/Citric acid | 200 | 69 | 1.34 |
| 19 | 200% 0610 ingot | Fe(SO4)/Citric acid | 50 | 80 | 1.34 |
| 20 | 200% 0610 ingot | Fe(SO4)/IDA | 100 | 49 | 1.34 |
| 21 | 200% 0610 ingot | IDA (240 ppm ligand) | 0 | 68 | 1.34 |
| 22 | 200% 0610 ingot | Fe(SO4)/2 IDA | 50 | 40 | 1.34 |
| 23 | 200% 0610 ingot | Fe(SO4)/2 IDA | 50 | 44 | 1.33 |
| 24 | 200% 0610 ingot | Fe(SO4)/2 IDA | 50 | 46 | 1.33 |
| | 200% 0610 ingot | Fe(SO4)/2 IDA | 100 | 30 | 1.35 |
| | 200% 0610 ingot | Fe(SO4)/2 IDA | 100 | 30 | 1.34 |
| 25 | 200% 0610 ingot/PAX18 | Fe(SO4)/2 IDA | 50 | 49 | 1.34 |
| 25 | 300% 0610 ingot | Fe(SO4)/2 IDA | 50 | 30 | 1.34 |
| 26 | 300% 0610 ingot | Fe(SO4)/2 IDA | 100 | 30 | 1.35 |
| | 200% 0610 ingot | Fe(SO4)/3 Gly | 50 | 72 | 1.34 |
| | 200% 0610 ingot | Fe(SO4)/2 Glu | 100 | 66 | 1.34 |
| | 200% 0610 ingot | Fe(SO4)/2 Lys | 100 | 56 | 1.34 |
| | 200% 0610 ingot | Fe(SO4)/4 Lys | 100 | 61 | 1.34 |
| | 200% 0610 ingot | Fe(SO4)/1 Lys 1 IDA | 100 | 49 | 1.34 |
| | 200% 0610 ingot | Fe(SO4)/2 Asp | 100 | 54 | 1.35 |
| SFAM | | | | | |
| 24 | 150% 0610 pellet (¼″) | none | 0 | 21 | 1.33 |
| 25 | 120 % 0610 pellet (⅜″) | none | 0 | 73 | 1.34 |
| 26 | 120% 0610 pellet (⅜″) | Fe(SO4)/Citric acid | 100 | 33 | 1.345 |
| 27 | 120% 0610 pellet (⅜″) | Fe(SO4)/2 IDA | 100 | 22 | 1.346 |
| 28 | 120% 0610 pellet (⅜″) | IDA (240 ppm ligand) | 0 | 63 | 1.35 |
| 29 | 120% 0610 pellet (⅜″) | Fe(SO4)/2 IDA | 50 | 32 | 1.332 |
| 30 | 120% 0610 pellet (⅜″) | Fe(504)/2 IDA | 50 | 38 | 1.34 |

The first three runs give the run times for control reactions using ingot, with the first using hydrochloric acid and the last one PAX18. Run times for runs 1 and 2 were 102 and 97, respectively even though they are nominally identical.

The run with PAX18 took longer (140 h) even though it used the same ingot as in Run 1 (Roto-1 ingot), which is not unexpected as the acid strengths of PAX -18 is less than that of HC1(aq). Regardless, the run times were similar whereas percent loading of A1 225%.

In general, the chelated complexes were prepared in situ by mixing aqueous solutions of the ligand and metal salt to give homogeneous solutions that are added to the ACH reaction. In most cases, the catalyst solution was added approximately 1 hour after the reaction had begun, as at this point most of the initial vigorousness has died down. For a two of the chelating ligands studied, SALEN and SALOPHEN, the ligand is also formed in situ from constituent components. These are ethylene-1,2-diamine (EN) and two equivalents salicylaldehyde (SAL) for SALEN and 1,2-diaminobenzene (OPD) and two equivalents salicylaldehyde (SAL) for SALOPHEN (typically about one hour after the reaction was started). For most chelating ligands, the complexing reaction is straightforward and occurs within seconds on mixing.

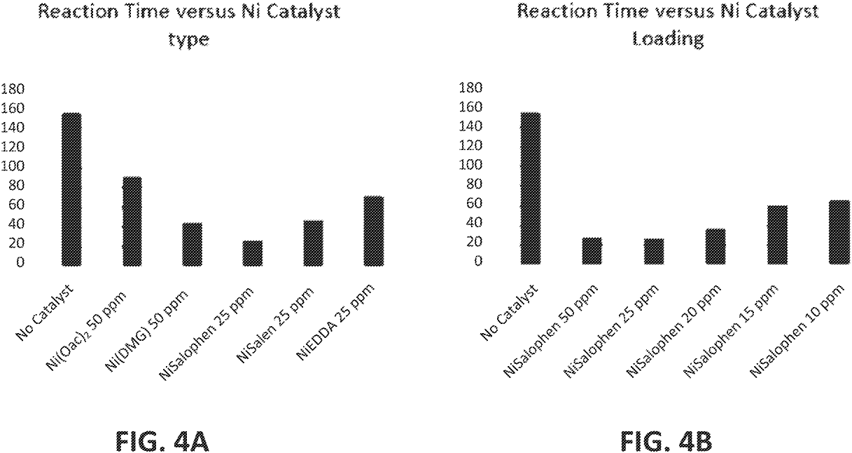

As shown in FIG. 4A, addition of nickel acetate (Ni(OAc)₂) as a catalyst at 50 ppm Ni had a modest catalytic effect, taking 90% as long as the uncatalyzed reaction. Addition 2 equivalents dimethylglyoxime ligand (DMG) and 50 ppm Ni(OAc)₂ boosted the rate such that run time was 50% that of the uncatalyzed reaction (50 h). Clearly the presence of chelating DMG ligands had a beneficial effect of the reaction rate. It is postulated that the chelating ligands stabilize the Ni(II) ion with respect to reduction to Ni(0). When the latter occurs, the metal aggregates to form colloids or particles which can also act as a HER catalyst but it is less effective than having the molecularly dispersed Ni(II) complex. Ni(II) with the SALOPHEN and SALEN ligands formed even better HER catalysts that take less than 30% of the uncatalyzed run time at loadings of only 25 ppm Ni. The loading study of NiSALOPHEN shown in FIG. 4B shows an optimum in catalysis at a loading of 25 ppm.

While Ni(II) chelate ligand complexes are clearly excellent catalysts for this process, nickel has a couple of drawbacks in its use: cost and safety. For one, it is generally not possible or practical to remove the catalyst from the product ACH and thus Ni(II) is present in the product at 1 -50 ppm levels. As a USP class 2A metal contaminant (see Table 3), levels above 20 ppm are not within specifications. Moreover, Ni is considerably more expensive than Fe or Cu on a mass basis. For this reason, we shifted to examine Fe-based catalysts as Fe salts are both inexpensive and Fe is well-tolerated as a contaminant by USP standards.

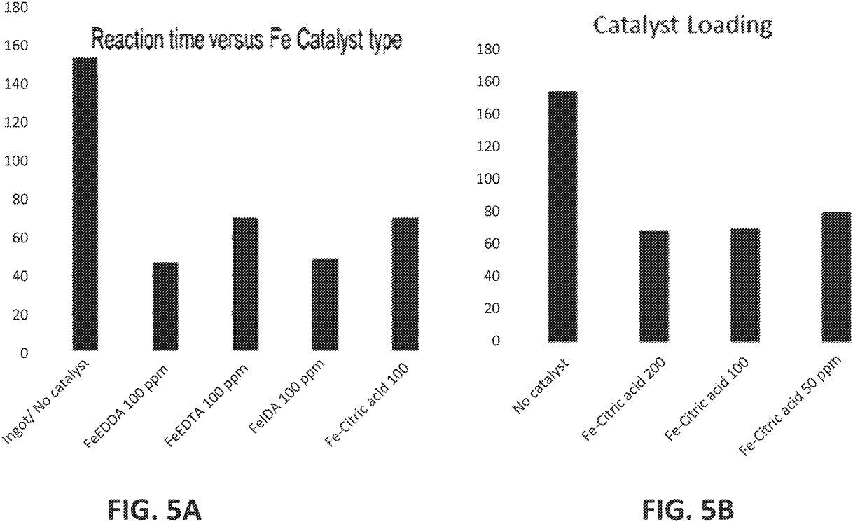

FIG. 5A shows the batch reaction times for ACH synthesis runs with and without (control) 100 ppm Fe(II) added as FeSO₄·7H₂O plus enough chelating ligand to form a 1:1 complex. The Fe(II) complex catalysts do differ in their run times with the best catalysts being those with EDDA or IDA chelating ligands. These catalysts gave a 2 fold rate enhancement over the uncatalyzed reaction (100 h to 47 h reaction time). Complexes with citric acid or EDTA showed a 70% enhancement (100 h to 70 h), which is interesting as EDTA offers 6 donor atoms to form a complex (2 nitrogens and 4 oxygens) and is expected to form the most stable complex of all of these ligands. Perhaps having open coordination sites is also important for activity. Complexes with citric acid were about as active as the EDTA complex which is promising in that citrate only offers oxygen donor atoms and may be expected to favor Al(III) complexation over Fe(II) complexation. Nonetheless, decent catalysis is observed. In a loading study, the amount of Fe(II)citric acid (1:1 complex) was varied from 200 ppm Fe to 50 ppm Fe (FIG. 5B). The rate enhancement did not drop appreciably upon going from 200 ppm (70 h) to 100 ppm Fe (69 h) but did decrease by ~ 7% going to 50 ppm Fe loading. Obviously there is a benefit to using ~ 100 ppm Fe to save on materials as higher loading do not accelerate the reaction further, and levels of 50 ppm or lower begin to lose efficacy.

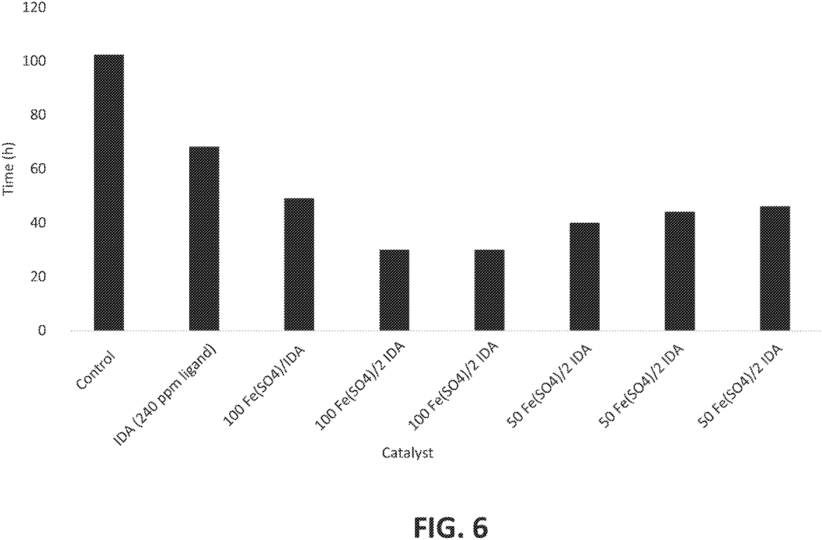

FIG. 6 shows the results of differing combinations of the IDA ligand with Fe(II). A listing of 100 Fe(SO₄)/2 IDA indicates that 100 ppm of Fe was added in the form of Fe(SO₄)·7H₂O plus two molar equivalents of the IDA ligand (480 ppm in IDA). As seen, this particular combination “100 Fe(SO₄)/2 IDA” gives the shortest reaction times which is 330% faster than the uncatalyzed reaction. Addition of just the ligand has a catalytic effect which is presumed due to eventual metalation with dissolved Fe(II) from the ingot, but this is not optimal as it takes a while for the Fe(II) concentration to build up. The 2 eq IDA per Fe(II) formulation is better than the 1:1 formulation with a total reaction time of 30 h vs 49 h, respectively, indicating the ligand stoichiometry is an important factor in the performance.

Combinations of Fe(II) with amino acids, especially those capable of tridentate complexes, i.e. glutamic acid, lysine, aspartate, revealed at best a 2-fold acceleration of the reaction with P0610 ingot 100 ppm Fe and 2 equivalents of the amino acid. The Fe(II) combination with glycine (bidentate only) at 50 ppm Fe(II) took 72 h to complete.

As laboratory scale reactions are not always representative of large-scale batch reactions, a number of oxidation reactions were examined at an intermediary level, generally using 10 - 12 kg of Al feedstock. These reactions tended to mirror the lab scale reactions (200 g Al) qualitatively, but run times were not identical and where generally a little longer, but still more than twice as fast or more than the uncatalyzed reaction. There are duplicate runs of the 100 ppm loading and triplicate of the 50

Various embodiments of the invention have been described in fulfillment of the various objectives of the invention. It should be recognized that these embodiments are merely illustrative of the principles of the invention. Numerous modifications and adaptations thereof will be readily apparent to those skilled in the art without departing from the spirit and scope of the invention.

1. A method of producing polyaluminum chloride comprising:
providing a feedstock comprising aluminum;
contacting the feedstock with a solution comprising hydrochloric acid, and one or more transition metal compounds; and
catalyzing formation of the polyaluminum chloride with the one or more transition metals.

2. The method of claim 1, wherein the one or more transition metal compounds comprise a transition metal complex.

3. The method of claim 2, wherein the transition metal complex comprises at least one chelating ligand.

4. The method of claim 3, wherein the at least one chelating ligand has denticity of 2 to 8.

5. The method of claim 3, wherein the at least one chelating ligand is selected from the group consisting of aminopolycarboxylic acids, amino acids, organic acids, amines, α-alcohol organic acids, oximes, polyphosphates, polyphosphonates, and Schiff-base derived ligands.

6. The method of claim 1, wherein the one or more transition metal compounds is a transition metal salt.

7. The method of claim 1, wherein the transition metal is selected from Groups 8-12 of the Periodic Table.

8. The method of claim 1, wherein the feedstock comprises aluminum ingots.

9. The method of claim 1, wherein the feedstock comprises aluminum pellets.

10. The method of claim 1, wherein the one or more transition metal compounds are present in the solution in a total amount of less than 500 ppm.

11. The method of claim 1, wherein the one or more transition metal compounds are present in the solution in a total amount of 5 ppm to 500 ppm.

12. The method of claim 1, wherein the formation of the polyaluminum chloride occurs at a reaction rate at least 200 percent faster relative to an absence of the one or more transition metal compounds from the solution.

13. The method of claim 12, wherein the reaction rate is 300-600 times faster.

14. The method of claim 1, wherein reaction rate of polyaluminum chloride formation is proportional to aluminum purity in the feedstock.

15. The method of claim 1, wherein stoichiometric excess of the aluminum is reduced relative to polyaluminum chloride production via hydrochloric acid solution free of the one or more transition metal compounds.

16. A method of producing polyaluminum chloride comprising:
providing a feedstock comprising aluminum;
contacting the feedstock with a solution comprising hydrochloric acid; and
catalyzing formation of the polyaluminum chloride with solid state transition metal or solid state transition metal alloy or combinations thereof.

17. The method of claim 16, wherein the solid state transition metal or solid state transition metal alloy is in particulate form, wire-mesh, wool, or combinations thereof.

18. The method of claim 16, wherein the solid state transition metal or solid state transition metal alloy is colloidal.

19. The method of claim 16, wherein the solid state transition metal or solid state transition metal alloy is formed by reduction of transition metal ions in the solution.

20. The method of claim 16, wherein the solid state transition metal or solid state transition metal alloy is operable to catalyze the hydrogen evolution reaction.

21-23. (canceled)
